(19) United States
(12) Patent Application Publication
(10) Pub. No.: US 2023/0416473 A1
(43) Pub. Date: Dec. 28, 2023

(54) ARTICLE MADE FROM A HEAVY PLASTIC MATERIAL

(71) Applicant: ETA SA MANUFACTURE HORLOGÈRE SUISSE, Grenchen (CH)

(72) Inventors: Julien DAHAN, Delémont (CH); Benoît SCHNELL, Grenchen (CH)

(73) Assignee: ETA SA MANUFACTURE HORLOGÈRE SUISSE, Grenchen (CH)

(21) Appl. No.: 18/036,550

(22) PCT Filed: Oct. 28, 2021
(86) PCT No.: PCT/EP2021/079960

§ 371 Date: May 11, 2023

(30) Foreign Application Priority Data
Nov. 24, 2020 (EP) 20209440.5

(51) Int. Cl. C08J 5/04; G04B 37/22; C08L 77/02; C08J 5/10

(52) U.S. Cl. CPC C08J 5/042; G04B 37/225; C08L 77/02; C08J 5/043; C08J 5/046; C08J 5/10; C08J 2377/10

(57) ABSTRACT

An article made from a material having a density between 2 and 7 g/cm³, the material comprising by weight for a total of 100%: a filler (2) made from a metal and/or ceramic material; at least one polymer (4); optionally at least one coupling agent (3) present in a percentage greater than or equal to 0% and less than 10%; optionally at least one reinforcement present in a percentage between 0 and 10%; optionally at least one pigment present in a percentage between 0 and 5%; optionally at least one diluent and/or a plasticiser present in a percentage between 0 and 5%. The polymer (4) is bonded to the filler (2) and the coupling agent (3) is respectively bonded to the polymer (4) and to the filler (2) by one or more bonds chosen from a hydrogen bond, a coordinate bond and an ionic bond.

### TECHNICAL FIELD OF THE INVENTION

The present invention relates to an article, and for example to a timepiece component, made from a heavy plastic material and resistant to impacts.

The present invention also concerns a method for manufacturing such an article made from a heavy plastic.

### TECHNOLOGICAL BACKGROUND

Many external components, such as middles and bracelets, are made from plastic materials. These components may be produced by moulding methods, which has the advantage of being able to obtain diverse shapes without any reworking operations. These components made from plastic materials have the feature of having a density close to 1 and therefore of being lightweight. This may constitute a disadvantage for the user desiring to wear on their wrist a watch having a certain weight.

To remedy this drawback, it has been proposed, for example in the document EP 2 482 142, to produce timepiece components, whether of the movement or of the external part, made from plastic materials filled with a high-density metal powder such as a tungsten powder. These components are produced by an injection moulding method which makes it possible to maintain the advantage of the shaping in the mould without subsequent reworking while increasing the density.

Thus, these materials combine certain advantages of plastics such as the ease of shaping by injection with those of metals such as the density, the cool touch and the metal appearance.

However, a reduction of the breaking strength and elongation in relation to the polymer matrix used can be observed in these materials. This reduction is attributed to a lack of cohesion of the material due to the incorporation of the metal powder of micrometric size into polymer chains of nanometric size. Thus, it is observed for a material comprising a metal (or ceramic) filler, a polyolefin (polyethylene, polypropylene) as polymer and polyurethane as coupling agent, this decrease in properties due to the lack of cohesion of the material.

This reduction of mechanical properties will impact the impact absorbing capacity of the material. This type of material is therefore not adapted to applications requiring an impact resistance, such as for example in the horological field for the production of middles, etc.

### SUMMARY OF THE INVENTION

The object of the present invention is to propose a new composition of heavy plastic material making it possible to improve the cohesion of the material and thereby the mechanical properties of the material.

The invention has a particularly interesting application in the field of horology; however the invention is not limited to such an application.

To this end, the present invention proposes an article made from a material comprising by weight for a total of 100%:
a filler made from a metal and/or ceramic material having a density greater than or equal to 3 g/cm³, said filler being present in a percentage greater than 50% and less than or equal to 85%,
at least one polymer present in a percentage greater than or equal to 15% and less than or equal to 50%,
optionally at least one coupling agent present in a percentage greater than or equal to 0% and less than 10%,
optionally at least one reinforcement present in a percentage between 0 and 10%,
optionally at least one pigment present in a percentage between 0 and 5%,
optionally at least one diluent and/or one plasticiser present in a percentage between 0 and 5%.

According to the invention, the polymer is bonded to the filler and/or the coupling agent is respectively bonded to the filler and to the polymer, when the material comprises at least one coupling agent, by one or more of the following bonds that are a hydrogen bond, a coordinate bond or an ionic bond.

These bonds establish between the oxidised surface, and/or electronic vacancies present at the surface of the filler, and groups of the polymer and/or of the coupling agent. For this purpose, the polymer and/or the coupling agent are carriers, by way of example, of one or more of the following groups: NHₓ, OH, COC, C═O, COOH. These bonds binding the filler, the polymer and if applicable the coupling agent make it possible to ensure a good cohesion of the material. They have the feature of having an interaction energy that is typically less than 100 kJ/mol or even 50 kJ/mol, which makes it possible to break the bonds between molecules during the temperature rise during the manufacturing method and thereby ensuring a better mixture and a better cohesion of the material after cooling and reforming the bonds.

The material thus developed has a sufficient stiffness with a Young's modulus greater than or equal to 2.5 GPa, a sufficient elongation at break that is greater than or equal to 5% and a load at break that is greater than or equal to 30 MPa, for a horological application. Furthermore, it has a good tenacity and has a density between 2 and 7 g/cm³.

Furthermore, the present invention relates to a method for manufacturing this material by moulding, by injection or by 3D printing.

The method has the feature that the base material for the filler is in the form of a powder having a BET greater than or equal to 0.01 m²/g, preferably 2 m²/g, more preferably 5 m²/g, so as to obtain a filler with a surface sufficiently reactive to form the hydrogen, ionic and/or coordinate bonds with the polymer and/or the coupling agent if the latter is present. The reactive surface whatever the type of ceramic (oxides, nitrides or carbides) or of metal (steel, tungsten, etc.) thus comprises hydroxides, oxides and/or electronic vacancies.

Other features and advantages of the present invention will become apparent in the following description of a preferred embodiment, presented by way of non-limiting example with reference to the appended drawings.

### BRIEF DESCRIPTION OF THE FIGURES

FIG. 1 shows a timepiece comprising a middle made from the heavy plastic material according to the invention.

FIG. 2 illustrates the interactions between the surface of the filler, the coupling agent and the polymer.

FIG. 3 schematically illustrates the hydrogen bonds that establish between the filler, the coupling agent and the polymer.

### DETAILED DESCRIPTION OF THE INVENTION

The present invention relates to an article made from a composite material comprising a plastic material and a metal or ceramic material.

By way of example, the article may be a constituent element of watches, jewellery, bracelets, etc.

The article may also be a constituent element of a bezel, for example a mount, an arm, a shoe.

In a non-limiting and non-exhaustive manner, the article according to the invention may also be a constituent element, or form the whole, of a sports article, a cooking article, a music article or instrument, a leathercraft or haberdashery article, an automotive or aeronautical component, a component for an electronic article (for example telephone protective casing, computer keyboard, computer keyboard keys, audio headset, etc.), a writing article, etc.

Advantageously, the article is a component of which the functionality requires a certain resistance to impacts and to shocks.

In the particular field of horology, this article may be for example an external component such as a middle, a back, a bezel, a push-button, a bracelet link, a dial, a hand, a dial index, etc.

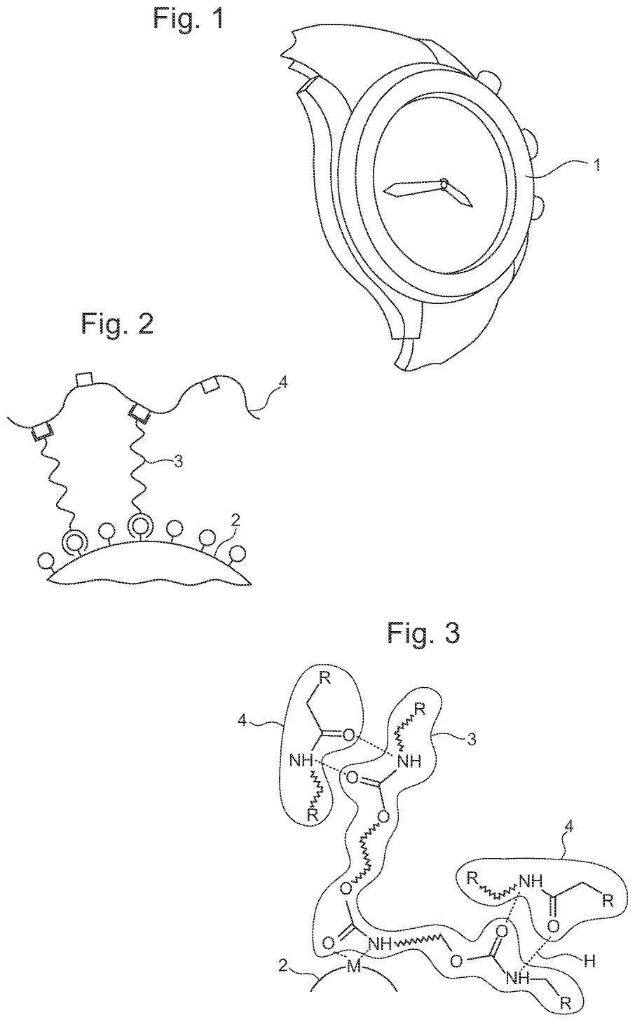

By way of illustration, a middle 1 made from the material according to the invention is shown in FIG. 1.

According to another example of embodiment (not shown), the article according to the invention may be a component of the movement, such as for example a plate.

According to the invention, the article is made from a material comprising at least two components that are a filler, metal and/or ceramic, and a polymer. Thus, the material may be qualified as a composite material.

Optionally, the material may comprise one or more coupling agents if the physiochemical interaction between the filler and the polymer is not sufficient.

Optionally, the material may comprise a reinforcement.

Optionally, the material may also comprise one or more pigments.

Optionally, the material may also comprise diluents and/or plasticisers.

The filler may be metal and/or ceramic.

For the metal material, it may concern a conventional carbon steel, a stainless steel, copper, a copper alloy, titanium, a titanium or also tungsten alloy. Preferably, it concerns a nickel-free stainless steel.

For the ceramic material, it may concern carbides, nitrides or oxides such as ZrO₂, CeO₂, ZnO, etc.

It may also concern a filler comprising a mixture of metal and ceramic materials.

The filler in its entirety is predominant in mass but less than or equal to 85% by weight. It is therefore by weight between 50 and 85% by weight (lower limit not comprised), for example between 50 and 75% or also between 50 and 65% (lower limit not comprised).

Preferably, it is in a percentage by weight between 60 and 80%, and even more preferably between 65 and 75%.

According to the invention, the filler is introduced during the manufacturing method in the form of a powder with a high specific surface (≥0.01 m²/g) which de facto, in the absence of specific treatment, will have on its surface modifications of its composition and/or defects and this whatever the type of metal or ceramic filler. It may concern oxides or hydroxides present on the oxidised surface of the powder and defects such as electronic vacancies, which will make it possible to interact via various bonds with the polymer and/or the coupling agent if the latter is present. FIG. 2 thus illustrates the interactions that establish between the surface of the filler 2, the coupling agent 3 and the polymer 4.

The material comprises one or more polymers capable of generating hydrogen, ionic and/or coordinate bonds with the filler and/or the coupling agent when it is present. All these physiochemical bonds have the feature of having a low interaction energy, typically between 5 and 100 kJ/mol, which makes it possible to break the bonds between molecules during the temperature rise during the injection or the 3D printing of materials, these physiochemical bonds being re-established during the cooling of the material after the injection or the 3D printing. This feature makes possible a better mixture, a better compatibility between the components and consequently a better cohesion of the material on the molecular scale and therefore a better overall cohesion of the material.

The polymer or all of the polymers represent a percentage by weight between 15 and 50% of the material (upper limit excluded), for example between 25 and 50% or also between 35 and 50% (upper limit excluded).

Preferably, the polymer or all of the polymers represent a percentage by weight between 20 and 40%, and more preferably between 25 and 35% of the material.

To form a hydrogen bond, the polymer comprises a hydrogen bond donor comprising a group with a hydrogen atom, such as an NH or OH group, and a hydrogen bond acceptor comprising a group with an atom more electronegative than hydrogen, such as nitrogen, oxygen or an atom of the group of halogens such as fluorine, chlorine, bromine, etc. The hydrogen bond establishes with the hydroxides and oxides present on the oxidised surface of the metal or ceramic filler. By way of example, the hydroxide group at the surface of the filler interacts with a C═O, R—OH, COC, R—NHₓR′ group of the polymer. Preferably, the hydrogen bond donor and acceptor are adjacent on the chain of the polymer. Still by way of example, the polymer may be a polyamide with the R—C(═O)—NH—R′ pattern therefore with the C═O group comprising the bond acceptor oxygen atom and the N—H group comprising the adjacent bond donor hydrogen atom.

The ionic bonds within the scope of the invention result from the interaction between a negatively charged basic function and a positively charged acid function. The bond establishes with transfer of an H⁺ ion from an OH group at the surface of the metal or ceramic filler towards the polymer. By way of example, the polymer may comprise an NHₓ group and more specifically be a polyamine, with R—NHₓ₊₁—R′+/MO— obtained after the acid-basic reaction.

Coordinate bonds are a particular type of covalent bond where the pair of shared electrons only comes from one of the atoms bonded by opposition to the conventional covalent bond where an electron comes from each of the bonded atoms. According to the invention, this bond more specifically implies a Lewis base formed by the polymer, associated with an electronic vacancy at the surface of the filler forming the Lewis acid. Any function-carrier polymer comprising a non-binding pair carrier atom may share this pair to “stabilise” the electronic vacancy. It may for example concern a nitrogen or oxygen non-binding pair in R(C═O)NR′, in RO(C═O)NR′ and in R(C═O)OR′. The polymer may also carry amine (NHₓ) or carboxylic acid (COOH) functions able to form this bond with an electronic vacancy at the surface of the filler. For example, polyurethanes and polyesters can be cited.

The material may comprise a coupling agent in a percentage between 0% and less than 10%, advantageously between 0.1 and 10%, more advantageously between 0.1 and 5%, even more advantageously between 0.5 and 3%. The coupling agent is also able to be bonded to the filler and to the polymer by one or more bonds chosen from the hydrogen, ionic and coordinate bonds such as described above. It will be specified that in the presence of a coupling agent, the bond establishes respectively between the coupling agent and the filler, and between the coupling agent and the polymer without necessarily direct bonds between the filler and the polymer. As for the polymer, the coupling agent may comprise at least one group chosen from C═O, COC, OH, NHₓ or also COOH. By way of example for hydrogen, ionic and coordinate bonds, it may concern polyurethane with the R—O—C═O—NH—R′ pattern. Preferably, the coupling agent has a long chain with 20 carbon atoms minimum. Still by way of example for hydrogen, ionic and/or of coordinate bonds, it may concern a hydroxysilane with an amine or amide function and advantageously 20 carbon atoms minimum on the chain. Still by way of example, it may concern ionic bonds with an acid-basic reaction taking place during the manufacturing method between the filler and the coupling agent with transfer of an H⁺ ion from an OH group at the surface of the filler. It may also concern ionic bonds between the coupling agent and the polymer comprising one or other respectively of the R—COOH carboxylic acid and R′—NHₓ amine functions forming the base with RCOO—/R′—NHₓ₊₁+ obtained after the acid-basic reaction. Alternatively, the polymer and the coupling agent may already be filled before being placed in presence. In which case, for the example above, the coupling agent and the polymer are respectively carriers either of the RCOO— basic function, or of the R′—NHₓ₊₁+ acid function.

Optionally, the material may also comprise a reinforcement in a percentage by weight between 0 and 10%, advantageously between 1 and 6%. The reinforcement may be present in various forms, for example, in the form of fibres or of particles. For example, it may concern glass fibres, glass beads, carbon fibres and/or aramid fibres with a fibre length less than or equal to 300 μm, and, preferably, 200 μm. The object of the reinforcement is to improve the tenacity of the material, to limit the removal of the material during the injection and/or to improve the electrical conductivity of the material.

Optionally, the material may also comprise one or more pigments in a total percentage between 0 and 5% by weight. The pigment may be an organic or mineral pigment. For example, it may concern carbon black for the black, diketopyrrolopyrrole for the red (e.g. Irgazin Red K3840LW by BASF), copper phthalocyanine for the blue (e.g. Heliogen Blue K7096 by BASF), a monoazo pigment for the yellow (e.g. Paliotol Yellow K1760 by BASF), etc.

Optionally, the material may also comprise diluents and/or plasticisers such as waxes (paraffins) or other application resins (terpenic, phenolic, etc.) to facilitate the application during the manufacture, all of these diluents and plasticisers being between 0 and 5% by weight.

By way of example and as shown in FIG. 3, the material comprises the metal filler M and/or the ceramic filler 2 with as polymer 4 polyamide and as coupling agent 3 polyurethane with preferably twenty carbon atoms minimum. In this example, the hydrogen bond between the polymer, the coupling agent and the filler is symbolised by dotted lines. More specifically, for this composition, the material comprises, for a percentage by weight of 100%, the metal filler such as a stainless steel and/or ceramic such as a zirconium oxide in a percentage between 65 and 80%, preferably between 65 and 75%, polyamide in a percentage between 19.5 and 34.5%, preferably between 24 and 34%, and polyurethane in a percentage between 0.5 and 5%, preferably between 1 and 3.5%.

By way of example, the material comprises a metal and/or ceramic filler and polyurethane with the polyurethane acting both as polymer and as coupling agent. In this example, no coupling agent distinct from polymer is therefore required because the interaction between the filler and the polymer is sufficient to ensure a good cohesion of the material at the end of the method.

By way of example, the material comprises a metal and/or ceramic filler with as polymer polyamide and as coupling agent a hydroxysilane with an amine or amide function, the coupling agent advantageously comprising 20 carbon atoms minimum.

By way of example, the material comprises a metal and/or ceramic filler with as polymer polyester and as coupling agent a hydroxysilane with an amine or amide function, the coupling agent preferably comprising 20 carbon atoms minimum.

The article is manufactured by injection moulding or by 3D printing. The method is characterised by the BET of the powder of the filler that must be sufficient to obtain a reactive surface. More specifically, the base material for the filler is a powder having a specific surface BET greater than or equal to 0.01 m²/g, preferably 2 m²/g, more preferably 5 m²/g measured according to the standard ISO 9277 of 2010.

For an injection moulding, the manufacturing method comprises the following steps making reference to the fillers, polymers, coupling agents, reinforcement and pigments described above:
a) Prepare granules of a few millimetres comprising by weight:
   the metal and/or ceramic filler having a density greater than or equal to 3 g/cm³, the filler being present in a percentage greater than 50% and less than or equal to 85%, preferably between 60 and 80% and more preferably between 65 and 75%,
   the polymer(s) present in their entirety in a percentage greater than or equal to 15% and less than or equal to 50%, preferably between 20 and 40% and more preferably between 25 and 35%,
   optionally at least one coupling agent present in a percentage greater than or equal to 0% and less than 10%, advantageously between 0.1 and 10%, more advantageously between 0.1 and 5%, even more advantageously between 0.5 and 3%,
   optionally a reinforcement present in a percentage between 0 and 10%,
   optionally the pigment(s) present in a percentage between 0 and 5%,
   optionally the diluent and/or the plasticiser or a mixture of diluents and/or of plasticisers, said diluent and/or said plasticiser or said mixture of diluents and/or of plasticisers being present in a percentage between 0 and 5%.
b) Injection mould said granules to form the article. The injection is performed in a mould that has a temperature between 60 and 100° C., preferably between 70 and 80° C., whereas the material during the injection has a temperature between 200 and 300° C., and, preferably, between 250 and 300° C.

In step a), the granules may be manufacturing by cutting a bead from the extrusion of the aforementioned raw materials. Advantageously, the coupling agent, if it is present, is introduced in a first phase into a hopper of the extruder either separately, or with the polymer granules before introducing the metal or ceramic powder in a second phase into the extruder. When the coupling agent is introduced separately, it may be introduced in the form of powder with a d90 less than or equal to 500 μm and, preferably, 315 μm or in liquid form. The pigment may be introduced during the extrusion and advantageously in a second phase. It can also be envisaged to mix it with the polymer granules just before the extrusion.

According to one variant, the metal, or ceramic, material and the coupling agent, if it is present, are introduced in a first phase into a hopper of the extruder so as to coat the metal, or ceramic, powder, with the coupling agent before introducing the polymer and the reinforcement.

Alternatively, the article may be manufactured by 3D printing such as by FDM (Fusion Deposition Moulding).

The article thus obtained comprises the metal, and/or ceramic, material and the plastic material comprising the polymer, and possibly the coupling agent, with products from the reaction between the filler, the polymer and the coupling agent during the extrusion or the injection. It also comprises the reinforcement and the pigment, if pigment and reinforcement exist.

It has a Young's modulus greater than or equal to 2.5 GPa, an elongation at break greater than or equal to 5% and a load at break greater than or equal to 30 MPa, these properties being measured according to the standard ISO 527-1A of 2019.

By way of example, tests were performed to manufacture by injection middles based on cylindrical granules having a diameter and a length respectively in the order of 4 mm and 1.5 mm. Tables 1 and 2 below take two examples with the resulting properties before and after ageing for 24 h in a ventilated oven without humidity control at 60° C. in Table 3. Resilience tests by impact pendulum on the middles have moreover demonstrated the good tenacity of the middles made with the aforementioned compositions.

TABLE 1
Example 1 - Composition

| | Name | Supplier | % by weight |
|---|---|---|---|
| Filler | Carpenter 3120 Metal Powder | MIM W08 | 72 |
| | Specific surface: 0.024 m2/g | ETA | |
| Polymer | PA11 Rilsan Clear G820 | Arkema | 27 |
| | Polyamide | (France) | |
| Coupling | Elastollan 1170 | BASF | 1 |
| agent | Polyurethane | (Germany) | |

TABLE 2
Example 2 - Composition

| | Name | Supplier | % by weight |
|---|---|---|---|
| Filler | Zirconium Oxide Powder | Comadur | 71 |
| | (5% alumina) | | |
| | Specific surface: 9.5 m2/g | | |
| Polymer | PA11 Rilsan Clear G820 | Arkema | 28 |
| | Polyamide | (France) | |
| Coupling | Elastollan 1170 | BASF | 1 |
| agent | Polyurethane | (Germany) | |

TABLE 3
Examples 1 and 2 - Properties before and after ageing between ( )

| | Stiffness - Young's | Elongation at | |
|---|---|---|---|
| | modulus | Break | Strain at Break |
| Example 1 | 3.0 GPa (3.1 GPa) | 16.3% (15.4%) | 55 MPa (55 MPa) |
| Example 2 | 4.4 GPa (4.4 GPa) | 9.7% (8.8%) | 63 MPa (61 MPa) |

1-29. (canceled)

30. An article made from a material having a density between 2 and 7 g/cm³, the material comprising by weight for a total of 100%:
a filler (2) made from a metal and/or ceramic material having a density greater than or equal to 3 g/cm³, said filler (2) being present in a percentage greater than 50% and less than or equal to 85%,
at least one polymer (4) present in a percentage greater than or equal to 15% and less than or equal to 50%,
at least one coupling agent (3) present in a percentage greater than or equal to 0% and less than 10%,
at least one reinforcement present in a percentage between 0 and 10%,
at least one pigment present in a percentage between 0 and 5%,
at least one diluent and/or a plasticiser present in a percentage between 0 and 5%,
said polymer (4) being bonded to the filler (2) and/or, when the material comprises at least one coupling agent (3), the coupling agent (3) being respectively bonded to the polymer (4) and to the filler (2) by one or more bonds chosen from a hydrogen bond, a coordinate bond and an ionic bond.

31. The article according to claim 30, wherein the filler (2) is present in a percentage by weight between 60 and 80% and wherein the polymer (4) is present in a percentage between 20 and 40%.

32. The article according to claim 30, wherein the filler (2) is present in a percentage by weight between 65 and 75% and wherein the polymer (4) is present in a percentage between 25 and 35%.

33. The article according to claim 30, wherein the coupling agent (3) is present in a percentage by weight between 0.1 and 10%.

34. The article according to claim 33, wherein the coupling agent (3) is present in a percentage by weight between 0.1 and 5%.

35. The article according to claim 33, wherein the coupling agent (3) is present in a percentage by weight between 0.5 and 3%.

36. The article according to claim 30, wherein the metal and/or ceramic material comprises at the surface oxides, hydroxides and/or electronic vacancies implied in the hydrogen, coordinate and ionic bonds with the polymer (4) and/or the coupling agent (3).

37. The article according to claim 30, wherein the polymer (4) and/or the coupling agent (3) are carriers of one or more of the groups chosen from NHₓ, OH, COC, C═O and COOH.

38. The article according to claim 30, wherein one bond is a hydrogen bond, the polymer (4) and/or the coupling agent (3) comprising a carrier group of a hydrogen atom that is a hydrogen bond donor and a carrier group of an element more electronegative than hydrogen which is a hydrogen bond accepter, said bond establishing with a hydroxide and oxide group at the surface of the filler (2).

39. The article according to claim 38, wherein said element is chosen from oxygen, nitrogen, chlorine, bromine and fluorine.

40. The article according to claim 38, wherein the groups respectively hydrogen bond donor and acceptor are adjacent on the polymer (4) and/or on the coupling agent (3).

41. The article according to claim 40, wherein the polymer (4) and/or the coupling agent (3) comprises a hydrogen bond donor that is an NHₓ group and a hydrogen bond acceptor that is a C═O group.

42. The article according to claim 41, wherein the polymer (4) is a polyamide.

43. The article according to claim 41, wherein the coupling agent (3) is a polyurethane.

44. The article according to claim 30, wherein one bond is an ionic bond with the polymer (4) carrying an NHₓ+ group bonded to an anion of the filler (2) and/or of the coupling agent (3).

45. The article according to claim 44, wherein the filler (2) carries an O— anion.

46. The article according to claim 44, wherein the coupling agent (3) carries an R—COO—0 anion.

47. The article according to claim 30, wherein one bond is a coordinate bond with the polymer (4) and/or the coupling agent (3) carrying carboxylic acid or amine functions forming said bond with an electronic vacancy at the surface of the filler (2).

48. The article according to claim 33, wherein the coupling agent (3) comprises a minimum of 20 carbon atoms.

49. The article according to claim 30, wherein said material comprises the filler (2) and the polymer (4) that is a polyurethane, without addition of said coupling agent (3).

50. The article according to claim 33, wherein said material comprises the filler (2) with as polymer (4) polyamide and as coupling agent (3) polyurethane.

51. The article according to claim 50, wherein said material comprises, for a percentage of 100%, said filler (2) in a percentage between 65 and 80%, said polymer (4) in a percentage between 19.5 and 34.5%, and said coupling agent (3) in a percentage between 0.5 and 5%.

52. The article according to claim 51, wherein said material comprises said filler (2) in a percentage between 65 and 75%, said polymer (4) in a percentage between 24 and 34%, and said coupling agent (3) in a percentage between 1 and 3.5%.

53. The article according to claim 33, wherein said material comprises the filler (2) with as polymer (4) polyamide and as coupling agent (3) a hydroxysilane with an amine or amide function.

54. The article according to claim 33, wherein said material comprises the filler (2) with as polymer (4) polyester and as coupling agent (3) a hydroxysilane with an amine or amide function.

55. The article according to claim 30 wherein the reinforcement is present in a percentage by weight between 1 and 6%.

56. The article according to claim 30 wherein said reinforcement is formed of glass fibres, of glass beads, of carbon fibres and/or of aramid fibres.

57. The article according to claim 30, wherein it concerns a component of the external part or of the horological movement.

58. Method for manufacturing an article according to claim 30, comprising:
a) a step of arranging base materials for the filler (2), the polymer (4), and optionally the coupling agent (3), the reinforcement and the pigment, with: the filler (2) made from a metal and/or ceramic material having a density greater than or equal to 3 g/cm³, said filler (2) being present in a percentage greater than 50% and less than or equal to 85%,
the polymer (4) present in a percentage greater than or equal to 15% and less than or equal to 50%,
the coupling agent (3) present in a percentage greater than or equal to 0% and less than 10%,
the reinforcement present in a percentage between 0 and 10%,
the pigment present in a percentage between 0 and 5%,
the diluent and/or the plasticiser present in a percentage between 0 and 5%,
b) a step of shaping the base materials to produce the article by an injection moulding technique or by a 3D printing technique,
wherein the base material for the filler (2) is a powder having a specific surface BET greater than or equal to 0.01 m²/g, preferably 2 m²/g, more preferably 5 m²/g and wherein, after the shaping step, said polymer (4) is bonded to the filler (2) and/or, when the material comprises at least one coupling agent (3), the coupling agent (3) is respectively bonded to the polymer (4) and to the filler (2) by one or more bonds chosen from a hydrogen bond, a coordinate bond and an ionic bond.
